(19) United States
(12) Patent Application Publication
(10) Pub. No.: US 2025/0156730 A1
(43) Pub. Date: May 15, 2025

(54) SYSTEMS AND METHODS FOR MINIMIZING DIMENSIONALITY OF A HIGH-DIMENSIONALITY DATASET DURING FEATURE ENGINEERING

(71) Applicant: Capital One Services, LLC, McLean, VA (US)

(72) Inventor: Michael LANGFORD, Plano, TX (US)

(73) Assignee: Capital One Services, LLC, McLean, VA (US)

(21) Appl. No.: 18/510,499

(22) Filed: Nov. 15, 2023

(51) Int. Cl. G06N 3/10

(52) U.S. Cl. CPC G06N 3/10

(57) ABSTRACT

Systems and methods for minimizing dimensionality of a high-dimensionality dataset during feature engineering. The system achieves this by using a tabular neural network to extract non-linear transformations of features without dramatically increasing the dimensionality of the original dataset. The system receives an original dataset for classification and a defined number of final features (e.g., dimensionality) that result from the synthetic feature creation and the neural network embedding process. Once an architecture of a model is determined, a model is fit on a synthetic feature set (e.g., a second dataset comprising synthetic features) with a given classification as a target.

### BACKGROUND

In recent years, the use of artificial intelligence, including, but not limited to, machine learning, deep learning, etc. (referred to collectively herein as “artificial intelligence models,” “machine learning models,” or simply “models”) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high quality can be complex and time-consuming. Additionally, data that is obtained may need to be categorized and labeled accurately, which can be difficult, time-consuming, and a manual task.

Second, artificial intelligence models, particularly models trained on time-series data, require extensive feature engineering. Feature engineering is a crucial process in machine learning and data science that involves creating new features or modifying existing ones in a dataset to improve the performance of a machine learning model. The goal of feature engineering is to extract meaningful information from raw data and represent it in a way that makes it easier for the model to learn patterns and make accurate predictions. It can significantly impact the success of a machine learning project—often more so than the choice of the machine learning algorithm itself. While feature engineering is a crucial step in machine learning, it also comes with various technical challenges and issues that data scientists and artificial intelligence practitioners must address. For example, during the feature engineering process, the number of possible combinations grows exponentially. This can lead to a substantial increase in dimensionality of the dataset, making it computationally expensive to process and train models on the dataset, particular if the dataset already has high-dimensionality. This technical issue may present an inherent problem with attempting to use artificial intelligence-based solutions for applications involving time-series data.

### SUMMARY

Systems and methods are described herein for novel uses and/or improvements to artificial intelligence applications, particularly in the context of feature engineering. As one example, systems and methods are described herein for minimizing dimensionality of a high-dimensionality dataset during feature engineering. The system achieves this by using a tabular neural network to extract non-linear transformations of features without dramatically increasing the dimensionality of the original dataset.

As one example, the system receives an original dataset for classification and a defined number of final features (e.g., dimensionality) that result from the synthetic feature creation and the neural network embedding process. Once an architecture of a model is determined, the model is fit on a synthetic feature set (e.g., a second dataset comprising synthetic features) with a given classification as a target. The embeddings are generated by feeding in testing observations and extracting hidden values from the nodes in the penultimate layer of the model, which results in a vector of values of the dimensionality specified by the defined number. After all embedding values are saved during the training process, the model is trained on the synthetic feature set for use in generating embeddings. The original synthetic features are then deleted to eliminate excess dimensionality. By doing so, the system may generate more accurate non-linear transformations of features using synthetic features that are fit to the original dataset such that each dimension of the synthetic feature may represent multiple other dimensions. Accordingly, the system minimizes dimensionality of a high-dimensionality dataset when feature engineering.

In some aspects, systems and methods for minimizing dimensionality of a high-dimensionality dataset during feature engineering for artificial intelligence models are described. For example, the system may receive a first dataset, wherein the first dataset comprises a first feature. The system may process the first dataset with a first model to generate a second dataset, wherein the second dataset comprises a second feature, wherein the second feature is a synthetic feature, and wherein the second feature is not included in the first dataset. The system may receive a first feature number, wherein the first feature number indicates an embedding dimension for a neural network. The system may determine a second model based on the first feature number, wherein the second model comprises the neural network. The system may fit the second model on the second dataset. The system may generate for display, on a user interface, a number of neural network embedding features equal to the first feature number.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for minimizing dimensionality of a high-dimensionality dataset during feature engineering, in accordance with one or more embodiments.

FIG. 2A shows an illustrative diagram of time-series data, in accordance with one or more embodiments.

FIG. 2B shows an illustrative user interface for automating model selection and feature engineering, in accordance with one or more embodiments.

FIG. 3 shows illustrative components for a system used to automate model selection based on dataset fittings of time-series data prior to hyperparameter optimization, in accordance with one or more embodiments.

FIG. 4 shows a flowchart of the steps involved in minimizing dimensionality of a high-dimensionality dataset during feature engineering, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

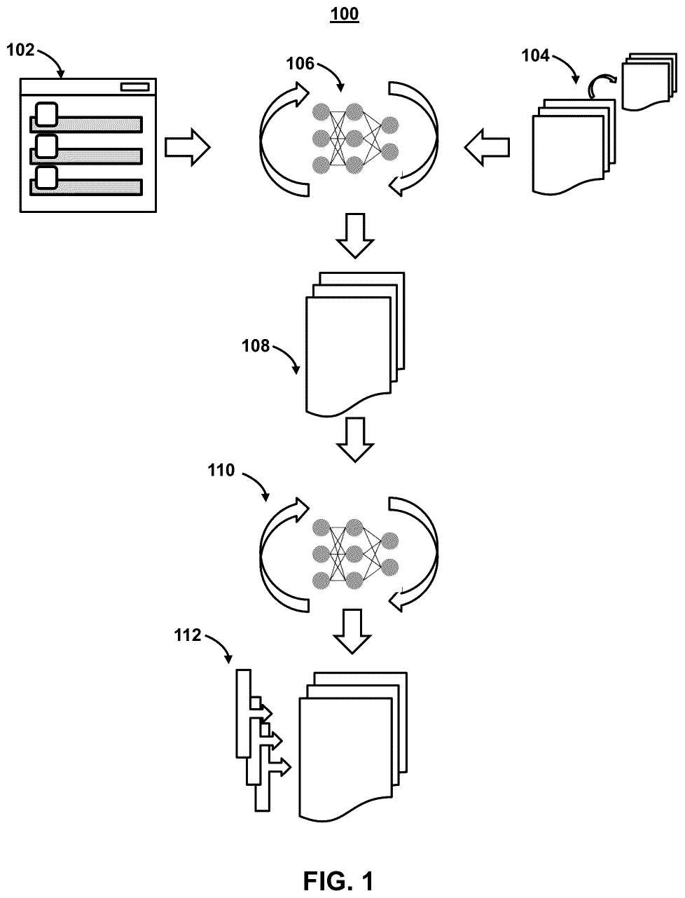

FIG. 1 shows an illustrative diagram for minimizing dimensionality of a high-dimensionality dataset during feature engineering, in accordance with one or more embodiments. For example, FIG. 1 shows architecture 100 that may be used for feature engineering for artificial intelligence models. Feature engineering is an important task in machine learning and other artificial intelligence applications involving deriving useful transformations of an original feature set that may be more important to a model generating predictions on a dataset. Architecture 100 may combine deep feature synthesis with an embedding generator using a tabular neural network to extract non-linear transformations of features in a way that does not dramatically increase the dimensionality of the original dataset.

As shown in architecture 100, the system may receive (e.g., via a user input on a user interface) a tabular dataset (e.g., dataset 104) for classification and a defined a number of final features (e.g., via user interface 102) resulting from the deep feature synthesis and neural network embedding process. For example, the number selected may be used to become the embedding dimension of the tabular neural network. As shown in FIG. 1, the system may receive a first dataset (e.g., dataset 104), wherein the first dataset comprises a first feature.

The system may then process the first dataset (e.g., dataset 104) with a first model (e.g., model 106) to generate a second dataset (e.g., dataset 108), wherein the second dataset comprises a second feature, wherein the second feature is a synthetic feature, and wherein the second feature is not included in the first dataset. For example, the system may apply, to the original dataset, a set of transformations to the original feature set to branch out to many synthetic features. The system may receive a first feature number (e.g., via user interface 102), wherein the first feature number indicates an embedding dimension for a neural network.

The system may determine a second model (e.g., model 110) based on the first feature number, wherein the second model comprises the neural network. For example, once the synthetic feature set has been determined, the architecture of a neural network (e.g., model 110) may be determined. The system may receive a number of neurons for the penultimate layer as well as the number of hidden layers to be used. The number of input neurons may be determined as the number of synthetic input features have been built by the first model (e.g., model 106). The number of neurons in the output layer is equal to the number of unique classes present in the dataset (e.g., dataset 104). Architecture 100 may be defined as having equally spaced numbers of neurons in each layer. The system may divide the difference between neurons in input and penultimate/embedding layers by the number of hidden layers and determine a linear difference between the number of neurons in each layer of the network. The system may use floor values that are taken in cases of non-integer numbers of neurons in layers. Once all the numbers of neurons for each layer is identified, the layers are built with a tanh activation function between them and a softmax activation function on the output layer for classification.

For example, the hyperbolic tangent function, often abbreviated as “tanh,” is an activation function used in artificial neural networks and other mathematical models. It is a sigmoidal function that maps input values to output values between −1 and 1. In contrast, the softmax activation function is a commonly used activation function in neural networks, particularly in the output layer of classification models. It is used to transform a vector of raw scores (also known as logits) into a probability distribution over multiple classes. The softmax function takes as input a vector of real numbers and produces as output a probability distribution over those numbers, ensuring that the sum of the probabilities is equal to 1.

Once an architecture of the neural network (e.g., model 110) is determined, the model is fit on only the synthetic feature set, with the classification as the target. This fit is performed using k-fold cross-validation, with a default K value of 10. For example, 9 sectors of a dataset (e.g., dataset 104) may be used for training and testing embeddings will be extracted for the 10th sector, and this process may repeat 10 times. The system may perform this so that the neural network is only extracting embeddings for observations that have not yet been seen in its training set, but also so that embeddings can be generated across the entire feature set. The embeddings are generated by feeding in testing observations and extracting hidden values from the nodes in the penultimate layer of the neural network, resulting in a vector of values of the dimensionality specified by the user. Finally, after all embedding values are saved on this training set, the neural network is trained on the entire synthetic feature set for use in generating embeddings in production. The original synthetic features are then deleted.

Once this process is complete, the system may return a number of neural network embedding features (e.g., features 112) equal to the specified dimensionality from the user (e.g., via a user interface). The system may also return a pipeline that performs the deep feature synthesis process on the original feature set and the trained neural network to generate embeddings from the new synthetic features and returns only the embeddings back to the user (e.g., via the user interface).

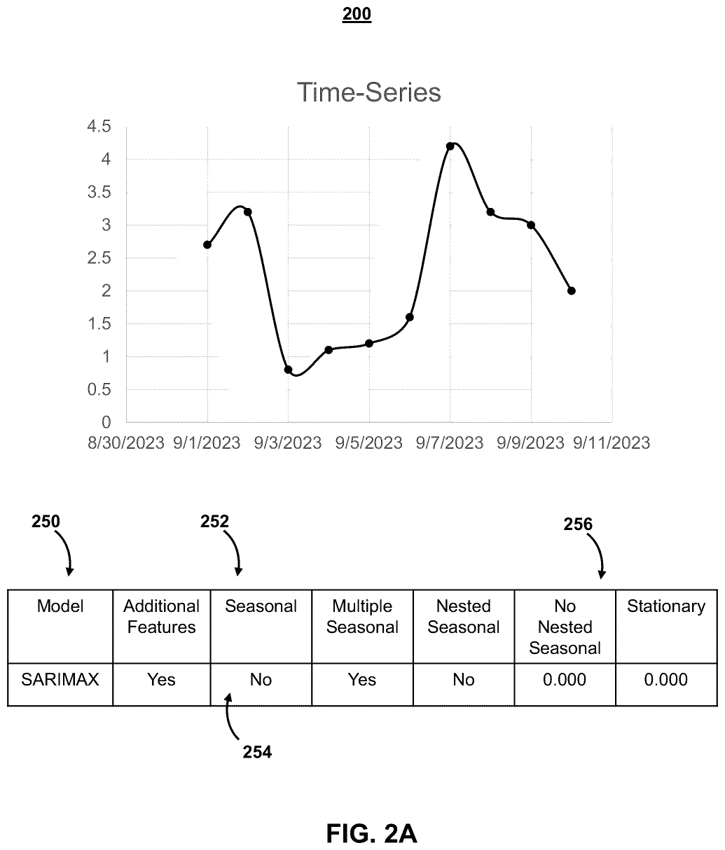

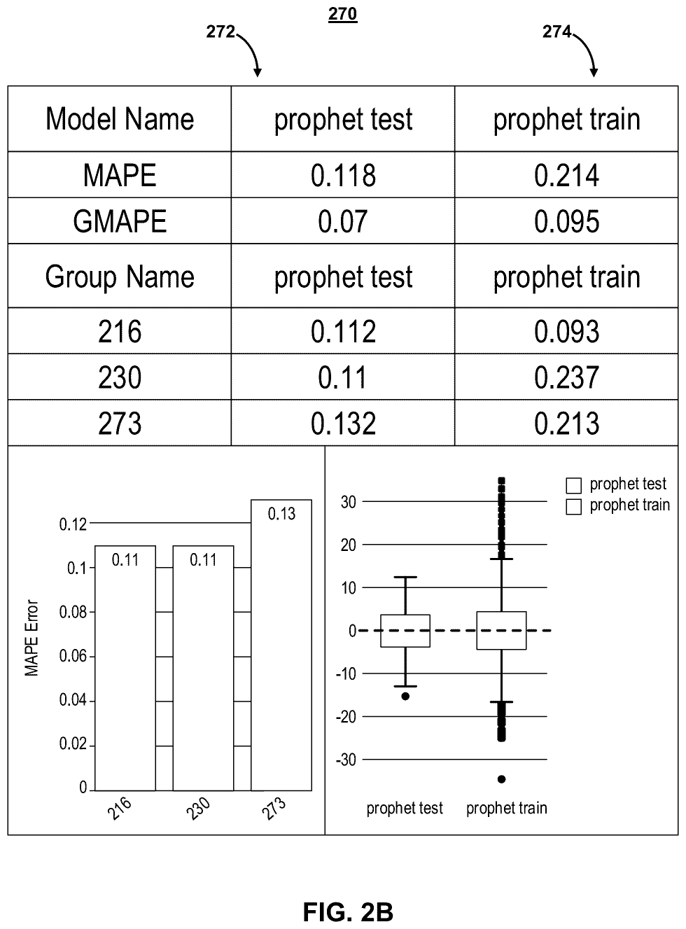

FIG. 2A shows an illustrative diagram of time-series data, in accordance with one or more embodiments. For example, dataset 200 may comprise data requiring feature engineering. Additionally or alternatively, a system may use dataset 200 to minimize development time in artificial intelligence models by automating model selection based on dataset fittings of time-series data. As part of that development, the system may perform feature engineering. As described herein, a model development life cycle may involve the various stages and processes involved in creating, training, evaluating, deploying, and/or maintaining models. It is a structured framework that helps guide the development of models in a systematic and effective manner.

As stated above, in the model development life cycle, choosing the best model to fit a given dataset and optimizing its hyperparameters is an incredibly time-consuming and tedious process. This is particularly true for time-series data. For example, in time-series forecasting, some models will be better suited to fit a given dataset of certain attributes such as the seasonal periods, presence of trends, and/or smoothness of the data. As such, certain time-series forecasting models may not be effective if there is no seasonality present in the data, whereas other time-series forecasting models may be very effective if the dataset is stationary. Accordingly, information about these attributes (e.g., a profile) of the time-series dataset may be used to help determine which model may be most effective at fitting a given dataset.

Fitting a dataset in artificial intelligence models may refer to the process of training a model using available data. Before fitting a dataset, the system may need to preprocess the data to make it suitable for training. This includes tasks such as handling missing values, scaling/normalizing features, encoding categorical variables, and splitting the dataset into training and testing sets. The system may then select an algorithm or model that is appropriate for a task. The choice of the model depends on the type of problem (classification, regression, clustering, etc.) and the characteristics of the data. The system may create an instance of the chosen model and configure its hyperparameters. Hyperparameters control various aspects of the learning process, and the system may need to experiment with different values to achieve optimal performance. The system may then use training data to train (fit) the model. This involves presenting the input features and corresponding target labels (or output) to the model so that it can learn the underlying patterns in the data. During training, the model may use a loss function to measure how well it is performing compared to the actual target values. The optimization algorithm (like stochastic gradient descent (SGD)) then adjusts the model's parameters (weights and biases) to minimize this loss function. The training process is usually performed in iterations or epochs. In each iteration, the model updates its parameters based on a subset of the training data. This helps the model gradually improve its performance. After each epoch, the system can evaluate the model's performance on a validation set. This helps the system monitor how well the model is generalizing to data it has not seen before.

For example, the system may receive a first dataset, wherein the first dataset comprises one or more categories of data trends. A dataset may comprise a structured collection of data points, usually organized into rows and columns, that is used for various purposes, including analysis, research, and training machine learning models. Datasets contain information related to a specific topic, domain, or problem and are used to extract meaningful insights or to train and evaluate algorithms and models. In the context of machine learning, a dataset typically consists of two main components: features and labels. Features (or attributes) are the characteristics or variables that describe each data point. Features are represented as columns in a tabular dataset. For example, if the system is working with a dataset of houses, features could include attributes like the number of bedrooms, square footage, location, etc. Labels, in contrast, may comprise targets and/or responses. For example, in supervised learning tasks, each data point often has an associated label that represents the output or target value the system wants the model to predict. For instance, if the system is building a model to predict house prices, the labels would be the actual prices of the houses in the dataset. Datasets come in various formats and sizes, ranging from small tables with a few rows and columns to large and complex databases containing millions of records. They can be generated manually, collected from real-world sources, or obtained from publicly available repositories. Common types of datasets include: structured datasets (e.g., tabular datasets with rows and columns, often stored in formats like CSV (Comma-Separated Values), Excel spreadsheets, or databases); image datasets (e.g., collections of images, often used for computer vision tasks; each image is treated as a data point, and the pixels constitute the features); text datasets (e.g., textual data, such as reviews, articles, or tweets, which can be used for natural language processing (NLP) tasks); time-series datasets (e.g., sequences of data points ordered by time, such as stock prices, weather measurements, or sensor readings); and graph datasets (e.g., data organized in a graph structure, with nodes and edges representing relationships between entities). Datasets are fundamental for various data-driven tasks, including exploratory data analysis, statistical analysis, and machine learning model development and evaluation.

Dataset 200 may comprise time-series data. As described herein, “time-series data” may include a sequence of data points that occur in successive order over some period of time. In some embodiments, time-series data may be contrasted with cross-sectional data, which captures a point in time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time-series analysis. For example, a time-series analysis may be useful to see how a given asset, security, and/or value related to other content changes over time. It can also be used to examine how the changes associated with the chosen data point compare to shifts in other variables over the same time period. For example, with regards to retail loss, the system may receive time-series data for the various subsegments indicating daily values for theft, product returns, etc.

The time-series analysis may determine various trends such as a secular trend, which describes the movement along the term; a seasonal variation, which represents seasonal changes; cyclical fluctuations, which correspond to periodical but not seasonal variations; and irregular variations, which are other nonrandom sources of variations of series. The system may maintain correlations for this data during modeling. In particular, the system may maintain correlations through non-normalization as normalizing data inherently changes the underlying data that may render correlations, if any, undetectable and/or lead to the detection of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches, depends heavily on the normalization choices. Thus, normalization may lead to lower model performance and more model errors. The use of a non-parametric bias test alleviates the need for normalization while still allowing the methods and systems to determine a respective proportion of error detections for each of the plurality of time-series data component models. Through this unconventional arrangement and architecture, the limitations of the conventional systems are overcome. For example, non-parametric bias tests are robust to irregular distributions while providing an allowance for covariate adjustment. Since no distributional assumptions are made, these tests may be applied to data that has been processed under any normalization strategy or not processed under a normalization process at all.

As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time-series data as a data stream. A given increment (or instance) of the time-series data may correspond to a data stream segment.

For example, in some embodiments, the analysis of time-series data presents comparison challenges that are exacerbated by normalization. For example, a comparison of original data from the same period in each year does not completely remove all seasonal effects. Certain holidays such as Easter and Lunar New Year fall in different periods in each year, hence they will distort observations. Also, year-to-year values will be biased by any changes in seasonal patterns that occur over time. For example, consider a comparison between two consecutive March months (i.e., compare the level of the original series observed in March for 2023 and 2024). This comparison ignores the moving holiday effect of Easter. Easter occurs in April for most years but if Easter falls in March, the level of activity can vary greatly for that month for some series. This distorts the original estimates. A comparison of these two months will not reflect the underlying pattern of the data. The comparison also ignores trading day effects. If the two consecutive months of March have different composition of trading days, it might reflect different levels of activity in original terms even though the underlying level of activity is unchanged. In a similar way, any changes to seasonal patterns might also be ignored. The original estimates also contain the influence of the irregular component. If the magnitude of the irregular component of a series is strong compared with the magnitude of the trend component, the underlying direction of the series can be distorted. While data may, in some cases, be normalized to account for this issue, the normalization of one data stream segment (e.g., for one component model) may affect another data stream segment (e.g., for another component model). Individual normalizations may distort the relationship and correlations between the data, leading to issues and negative performance of a composite data model.

Table 250 may indicate outputs of a plurality of statistical models. For example, each row of table 250 may correspond to a model used to generate predictions based on a given dataset (e.g., “SARIMAX” in table 250), whereas each column of table 250 may correspond to a given statistical model that performs a different statistical analysis. For example, a first model of the plurality of statistical models (e.g., corresponding to column 252) may determine a value used to predict seasonality in data. The system may then use the value (e.g., value 254) to apply a score.

As referred to herein, a statistical analysis may encompass techniques used to analyze data and extract meaningful insights. These techniques help researchers, analysts, and data scientists understand patterns, relationships, and trends in data. In some embodiments, the system may determine whether data is spiky based on value 256.

For example, for automated model selection for time-series datasets, it is important to be able to determine whether or not the dataset contains “spiky” data-data that contains large swings as certain time-series models cannot be fit properly to data that exhibits spikiness. The system may achieve this by scanning a given dataset for periods of spikiness that are independent of the specific range of the overall dataset and do not use any measure of variance of the data.

For example, the system may receive a time-series dataset. The system may then determine a number of points to check within a sliding window across the dataset, as well as a maximum tolerable percent change with respect to the current range of the data in the sliding window that determines the threshold for calling data spiky (e.g., a “spiky threshold”), and its value may be between 0 and 1.

For this process, the system iterates through the time-series dataset from the beginning, choosing a sliding window of a size of the number (N) of points the user selected. For each sliding window of N points, the system finds the range between the maximum and minimum values in the window. The system then determines the successive differences between each value of the points in the window and divides them by the window's range. If the absolute value of any of these values is greater than the spiky threshold value set by the user, the system exits of the process and returns the dataset with an indication that it contained spiky data. If it ran to completion without identifying any spiky data, the system exits and returns an indication that it did not identify spiky data at the given parameters.

One type or category of statistical analysis is descriptive statistics. Descriptive statistics summarize and describe the main features of a dataset. This includes measures like mean, median, mode, standard deviation, variance, and percentiles. Descriptive statistics provide a basic overview of the data's central tendency, variability, and distribution. Table 250 may list these results as an array of data values that comprises an aggregate statistical profile for a given model, wherein the given model may be used to generate predictions based on the dataset.

Another type of statistical analysis is inferential statistics. Inferential statistics involve making predictions or drawing conclusions about a population based on a sample of data. Techniques like hypothesis testing, confidence intervals, and regression analysis are used to infer insights about larger datasets. Another type of statistical analysis is hypothesis testing. Hypothesis testing is used to make decisions about whether a particular hypothesis about a population is likely true or not. It involves comparing sample data to a null hypothesis and assessing the likelihood of observing the data if the null hypothesis is true.

Another type of statistical analysis is regression analysis. Regression analysis is used to understand the relationship between one or more independent variables (features) and a dependent variable (target). It helps model the relationship and predict the value of the dependent variable based on the values of the independent variables. Another type of statistical analysis is analysis of variance (ANOVA). ANOVA is used to analyze the differences among group means in a dataset. It is often used when there are more than two groups to compare. ANOVA assesses whether the means of different groups are statistically significant. Another type of statistical analysis is a chi-square test. The chi-square test is used to determine if there is a significant association between categorical variables. It is commonly used to analyze contingency tables and assess whether observed frequencies are significantly different from expected frequencies. Another type of statistical analysis is time-series analysis. Time-series analysis focuses on data points collected over time. Techniques like moving averages, exponential smoothing, and autoregressive integrated moving average (ARIMA) models are used to analyze trends, seasonality, and patterns in time-series data. Another type of statistical analysis is cluster analysis. Cluster analysis is used to group similar data points together based on their characteristics. It is often used for segmentation and pattern recognition in unsupervised learning tasks.

Another type of statistical analysis is factor analysis. Factor analysis is used to identify patterns of relationships among variables. It aims to reduce the number of variables by grouping them into latent factors that explain the underlying variance in the data. Another type of statistical analysis is principal component analysis (PCA). PCA is a dimensionality reduction technique that transforms high-dimensional data into a lower-dimensional space while retaining as much variance as possible. It is commonly used to reduce noise and extract important features from data.

FIG. 2B shows an illustrative user interface for automating model selection and feature engineering, in accordance with one or more embodiments. For example, user interface 270 may represent an interface used to perform model selection and/or adjust hyperparameter optimization. For example, user interface 270 may be used to review model and/or hyperparameter performance (e.g., in order to train, tune, and fit models and/or hyperparameters).

The system may perform hyperparameter tuning to optimize the model's settings for better performance. For example, the system may compare test performance 272, which may comprise a performance performed by a model on test data, to train performance 274, which may comprise a performance performed by a model on test data to train performance. Once the training is complete and the system meets a threshold level of performance, the system can evaluate its performance on a separate testing dataset. This gives the system a final assessment of how well the model is expected to perform on new, unseen data. If the model meets the performance requirements, the system can deploy it to make predictions on new data. This may involve integrating the trained model into another application or system. The fitting process involves a balance between underfitting (when the model is too simple to capture the underlying patterns) and overfitting (when the model learns noise in the training data and performs poorly on new data). Regularization techniques and careful model selection can help mitigate these issues. Overall, fitting a dataset involves selecting a model, training it on the data, monitoring its performance, and optimizing its settings for the best results.

As referred to herein, a “modeling error” or simply an “error” may correspond to an error in the performance of the model. In some embodiments, an error may be used to determine an effect on performance of a model. For example, an error in a model may comprise an inaccurate or imprecise output or prediction for the model. This inaccuracy or imprecision may manifest as a false positive or a lack of detection of a certain event. These errors may occur in models corresponding to a particular hyperparameter, which result in inaccuracies for predictions and/or output based on the hyperparameter, and/or the errors may occur in models corresponding to an aggregation of multiple hyperparameters that result in inaccuracies for predictions and/or outputs based on errors received in one or more of predictions of the plurality of hyperparameters and/or an interpretation of the predictions of the models based on the plurality of hyperparameters. In some embodiments, each model (or statistical test) of the plurality of models (or statistical tests) may test for a different statistical variation (e.g., smoothness, spiky data, seasonality, etc.). To determine the statistical variation for the first model over the first time period, the system may need to calculate descriptive statistics that provide insights into the variability of the data. For example, the system may gather the data (e.g., from the first dataset) over the first time period. This could be any relevant metric that the system wants to analyze, such as accuracy, error rate, revenue, etc., as well as other statistical metrics (e.g., mean, average, standard deviation, etc.). For example, the system may calculate descriptive statistics such as mean, variance, and/or standard deviation. To determine a mean, the system may add up all the data points and divide by the number of data points to get the average. The mean provides an overall sense of central tendency. To determine variance for each data point, the system calculates the squared difference from the mean. The system may then sum up these squared differences and divide by the number of data points. Variance measures how much the data points spread out from the mean. For standard deviation, the system takes the square root of the variance. The standard deviation is a commonly used measure of dispersion or spread. For example, the system may determine a first time period for a first model (or statistical test) of the first plurality of models (or statistical tests). The system may determine a first statistical variation for the first model over the first time period. The system may determine a feature number of the first plurality of feature numbers for the first model based on the first statistical variation.

Hyperparameter tuning is the process of selecting the optimal values for hyperparameters in a machine learning model. Hyperparameters are parameters that are set before the learning process begins and control various aspects of the training process. They are not learned from the data but are determined by the user or data scientist based on domain knowledge, experimentation, and heuristics. Some examples of hyperparameters in machine learning algorithms include learning rate, regularization strength, number of hidden units or layers in a neural network, kernel parameters in support vector machines, and so on. For example, hyperparameters can include learning rate, batch size, number of hidden layers in a neural network, regularization strength, kernel size in a convolutional neural network, and more. These choices influence how the model learns from the data and generalizes to new, unseen data. Hyperparameter performance may be a measure of how effective a particular set of hyperparameters is in producing a model that performs well on a specific task. To do so, the system may use techniques like cross-validation or holdout validation, where the dataset is split into training and validation subsets. Different sets of hyperparameters are tried, and the performance of the resulting models is measured on the validation data. For example, the goal when tuning hyperparameters is to find the best combination that leads to optimal model performance. This can be a delicate balance, as adjusting hyperparameters too much might lead to overfitting or poor generalization, while not adjusting them enough could result in an underperforming model.

Hyperparameter tuning is important because the performance of a machine learning model is highly dependent on the values of these hyperparameters. Poorly chosen hyperparameters can lead to suboptimal model performance, including overfitting or underfitting. The goal of hyperparameter tuning is to find the set of hyperparameters that results in the best possible performance on the validation or test dataset. Hyperparameter tuning is typically an iterative process that involves trying different values for various hyperparameters, observing the impact on performance, and refining the choices based on those observations. Automated techniques, such as grid search, random search, and more advanced methods like Bayesian optimization, are often employed to systematically explore the hyperparameter space and find the combination that leads to the best performance on the validation data.

There are several methods for hyperparameter tuning, including grid searching. This involves specifying a grid of possible hyperparameter values and systematically trying out all combinations of values. It is simple but can be computationally expensive. Another example of hyperparameter tuning is random search. Instead of trying all possible combinations, random search samples a fixed number of random combinations from the hyperparameter space. This can be more efficient than a grid search. Another example of hyperparameter tuning is Bayesian optimization. This is a more sophisticated approach that builds a probabilistic model of the relationship between hyperparameters and model performance. It then uses this model to intelligently select the next set of hyperparameters to try. Another example of hyperparameter tuning is gradient-based optimization. Some frameworks allow for using gradient-based optimization techniques to directly optimize hyperparameters alongside the model parameters.

The process of hyperparameter tuning involves a balance between exploration and exploitation. Exploring different hyperparameter values helps to find a better region in the hyperparameter space, while exploiting promising regions helps to refine the hyperparameter settings for optimal performance. Overall, hyperparameter tuning is a crucial step in the machine learning pipeline to achieve the best possible model performance on new, unseen data.

For example, the system may tune the first untuned hyperparameter to the specific value. To make an untrained model useful, it needs to go through a training process. During training, the model is exposed to a labeled dataset, and it learns to adjust its parameters based on the input features and corresponding target labels. The optimization process (often using techniques like gradient descent) iteratively updates the model's parameters to minimize the difference between its predictions and the actual labels in the training data. For example, the entire hyperparameter tuning process may be guided by a JSON that contains the following: every possible model; for each model, a set of hyperparameters that are “eligible” for tuning; and for each hyperparameter, a data type of the hyperparameter (integer, float, categorical, string, etc.) and a range of possible values for the hyperparameter.

From a main template of all this documented model and hyperparameter information, the system will pull a copy of the template to adjust for the specific dataset. For the specific dataset, statistical tests may be performed to determine specific information about the profile of the dataset, such as the presence of trend, whether there is additive or multiplicative seasonality, or the length of the seasonal periods in the dataset. Any specific values found are then mapped to the specific hyperparameters they relate to in each of the candidate models. The system may then update the hyperparameter tuning JSON file to set the known value for the hyperparameter to what was discovered through the statistical tests. As such, every considered model may have this hyperparameter value pinned, and it will not be considered for any tuning as it is already known.

The candidate models are then fit and tuned to the dataset. The system returns the model that performs best using an expanding window validation strategy. The system may also return a simple report detailing the known hyperparameters about the dataset profile that are discovered with the tests. Through this training process, the model learns to recognize patterns, relationships, and features in the data, allowing it to make accurate predictions or classifications on new, unseen data. The process of training a model involves adjusting its parameters to fit the training data and capture the underlying patterns, which is why an untrained model is not yet capable of performing the desired task.

In some embodiments, the system may tune the first untuned hyperparameter to the specific value to generate a tuned first model. The system may then generate for display, on a user interface, a recommendation for using the tuned first model for time-series forecasting. For example, generating recommendations on a user interface may involve leveraging algorithms and techniques to suggest relevant items, content, or actions to users based on their preferences, behaviors, and/or historical interactions.

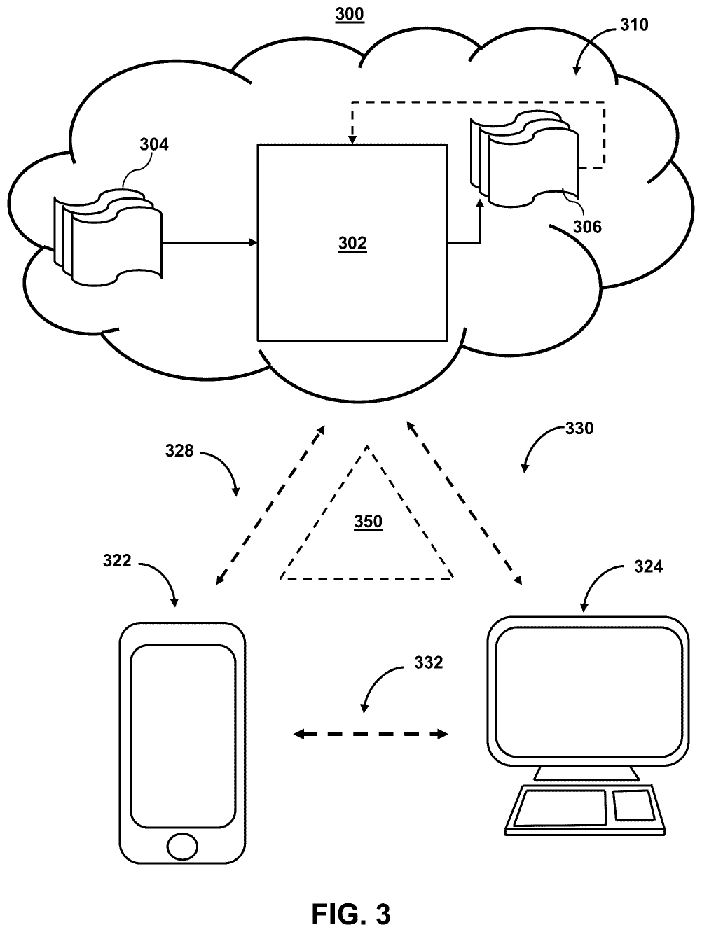

FIG. 3 shows illustrative components for a system used to automate model selection based on dataset fittings of time-series data prior to hyperparameter optimization, in accordance with one or more embodiments. For example, FIG. 3 may show illustrative components for minimizing development time in artificial intelligence models by automating model selection based on dataset fittings of time-series data prior to hyperparameter optimization. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., recommendations, queries, and/or notifications).

Additionally, as mobile device 322 and user terminal 324 are shown as monitors, these displays also act as user input interfaces. It should be noted that in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, virtual private networks, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., one or more categories of data trends and/or other predictions).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302 (e.g., one or more categories of data trends and/or other predictions).

In some embodiments, the model (e.g., model 302) may automatically perform actions based on outputs 306. In some embodiments, the model (e.g., model 302) may not perform any actions. The output of the model (e.g., model 302) may be used to generate recommendations and/or other predictions.

System 300 also includes API (Application Programming Interface) layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of API layer 350 may provide integration between front-end and back-end. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDoS protection, and API layer 350 may use RESTful APIs as standard for external integration.

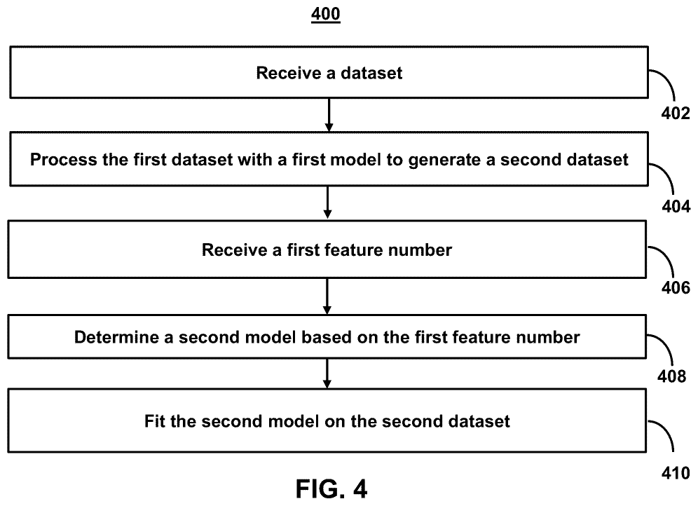

FIG. 4 shows a flowchart of the steps involved in minimizing dimensionality of a high-dimensionality datasets during feature engineering, in some embodiments. For example, the system may use process 400 (e.g., as implemented on one or more system components described above) in order to minimize development time in artificial intelligence models by feature engineering based on dataset fittings of time-series data. For example, feature engineering is a crucial process in machine learning and data analysis. It refers to the process of selecting, creating, or transforming features (input variables or attributes) from the raw data to improve the performance of a machine learning model. The goal of feature engineering is to extract meaningful information from the data, reduce noise, and present it in a format that a machine learning algorithm can effectively learn from.

At step 402, process 400 (e.g., using one or more components described above) receives a dataset. For example, the system may receive a first dataset, wherein the first dataset comprises a first feature. For example, the first dataset may comprise payment card transaction data over a given time period. For example, payment card transaction data refers to the records of financial transactions made using credit cards, debit cards, and/or other electronic payments. These transactions involve the exchange of goods or services in return for payment, and the details of each transaction are recorded by the credit card issuer and the merchant involved. Transaction data is highly valuable for various purposes, including financial analysis, fraud detection, and consumer behavior analysis.

At step 404, process 400 (e.g., using one or more components described above) processes the first dataset with a first model to generate a second dataset. For example, the system may process the first dataset with a first model to generate a second dataset, wherein the second dataset comprises a second feature, wherein the second feature is a synthetic feature, and wherein the second feature is not included in the first dataset. In the context of modeling, a feature input (often simply referred to as a “feature”) is a specific attribute or variable that is used as an input to a model for making predictions or classifications. Features are the measurable characteristics of the data that the machine learning algorithm uses to learn patterns and relationships in the data. In a dataset, each data point (also known as an observation or instance) is described by a set of features. These features represent the input variables that the model uses to make predictions or decisions. The goal of feature engineering is to select and transform relevant features that can help the model capture the underlying patterns in the data and improve its predictive performance.

In some embodiments, the second feature may be based on a statistical variation in the first dataset over a first time period. For example, each dataset may have different statistical variations (e.g., smoothness, spiky data, seasonality, etc.). To determine the statistical variation for the first dataset over the first time period, the system may need to calculate descriptive statistics that provide insights into the variability of the data. For example, the system may gather the data (e.g., form the first dataset) over the first time period. This could be any relevant metric that the system wants to analyze, such as accuracy, error rate, revenue, etc., as well as other statistical metrics (e.g., mean, average, standard deviation, etc.). For example, the system may calculate descriptive statistics such as mean, variance, and/or standard deviation. To determine a mean, the system may add up all the data points and divide by the number of data points to get the average. The mean provides an overall sense of central tendency. To determine variance, for each data point, the system calculates the squared difference from the mean. The system may then sum up these squared differences and divide by the number of data points. Variance measures how much the data points spread out from the mean. For standard deviation, the system takes the square root of the variance. The standard deviation is a commonly used measure of dispersion or spread. For example, the system may determine a first time period for a first dataset. The system may determine a first statistical variation for the first dataset over the first time period. In some embodiments, the second feature may be based on a profile matrix (e.g., representing the statistical variation) for the first dataset.

In some embodiments, the system may compare feature numbers to one or more thresholds to determine whether or not to filter, score, and/or disqualify the feature number. The system may then determine a difference between the feature number and the threshold value. The system may select the threshold based on characteristics of the dataset (e.g., size, type, age, etc.).

At step 406, process 400 (e.g., using one or more components described above) receives a first feature number. For example, the system may receive a first feature number, wherein the first feature number indicates an embedding dimension for a neural network. For example, the system may receive a user input that defines a number of final features to end up with as a result of the deep feature synthesis and neural network embedding process. The number selected will become the embedding dimension of the tabular neural network.

In some embodiments, the system may retrieve a first feature from the first dataset. The system may then perform a first function on the first feature to generate the second feature. For example, the first model may automatically generate new features by applying various aggregation, transformation, and/or combination functions to the original dataset's features. These functions may include operations like summation, averaging, counting, time-based calculations, etc.

In some embodiments, the system may recursively perform a first function on the first feature. The system may then determine that a stopping condition for the first function is met. The system may end a recursive performance of the first function based on the stopping condition being met. The system may determine the second feature based on a result of the recursive performance of the first function. For example, the system may operate the first model in a recursive or hierarchical manner. For example, the system may start by creating basic features from the raw dataset. The system may then apply functions to these features to generate more complex features. This recursive process continues until a predefined stopping condition is met or when a desired level of feature complexity is reached.

In some embodiments, the system may determine a first temporal pattern in the first dataset. The system may generate the second feature based on the first temporal pattern. For example, the system may process time-series data and create features that capture temporal patterns, trends, and/or seasonality. In some embodiments, the system can generate lag features, rolling statistics, and other time-based transformations.

In some embodiments, the system may determine a first relationship in the first dataset. The system may perform a first function based on the first relationship to generate the second feature. For example, the relationships between different entities in the dataset may be considered by the system. As one example, in a relational database, the system might have multiple tables linked by keys. The system can automatically generate features by aggregating or transforming data across these related tables.

In some embodiments, the first model may also perform additional steps on the first data. For example, the system may generate a plurality of features based the first dataset. The system may filter the plurality of features based on respective importance metrics. The system may select the second feature for inclusion in the second dataset based on filtering the plurality of features based on the respective importance metrics. For example, after generating a large number of features, the system may perform feature selection to retain the most relevant and informative ones, discarding redundant or unimportant features to prevent overfitting.

To determine feature importance (or a respective importance metric), the system may determine a model used to generate the feature. For example, if the system uses tree-based models like decision trees, random forests, or gradient boosting trees (e.g., XGBoost, LightGBM), the system can use feature importance scores provided by the algorithms. These scores are based on how often a feature is used for splitting in the tree and how much it reduces impurity or error. In another example, the system may use a permutation importance. Permutation importance is a model-agnostic technique. It involves shuffling the values of a single feature and measuring how much the model's performance (e.g., accuracy or mean squared error) degrades. Features that, when shuffled, result in a significant drop in performance are considered important. Libraries like scikit-learn provide tools to compute permutation importance. In another example, the system may use recursive feature elimination. Recursive feature elimination is a feature selection method that estimates feature importance by iteratively removing the least important features and evaluating model performance at each step. Features that, when removed, cause a significant decrease in performance are considered important.

In some embodiments, the first model performs additional transformations. For example, the system may receive a third feature number, wherein the third feature number indicates an additional transformation to be applied to the first dataset. The system may generate the second dataset based on the additional transformation. Feature transformation is a process in data preprocessing and feature engineering that involves changing the way a feature is represented or encoded in a dataset without altering its fundamental meaning or information content. The goal of feature transformation is to make the data more suitable for a particular machine learning algorithm or to reveal underlying patterns and relationships that may not be apparent in the original feature space. Feature transformation techniques can be applied to both numerical, categorical, and/or temporal features.

Numerical feature transformations may include normalization. Normalization may comprise scaling numerical features to a common range, typically between 0 and 1 or with a mean of 0 and standard deviation of 1. This ensures that features with different scales do not dominate the learning process. Another example of numerical feature transformations is a logarithmic transformation. A logarithmic transformation may comprise taking the logarithm of numerical features, which can help make data more symmetric, especially when dealing with skewed distributions. Another example of numerical feature transformations is a Box-Cox transformation. A Box-Cox transformation may comprise a family of power transformations that can be applied to make data more normally distributed. Another example of numerical feature transformations is a polynomial feature. A polynomial feature comprises creating new features by raising existing features to various powers, which can capture non-linear relationships between variables. Another example of numerical feature transformations is a binning or discretization. Binning may comprise dividing numerical features into bins or discrete intervals. This can help capture non-linear patterns and reduce the sensitivity to outliers.

Categorical feature transformations may include one-hot encoding. One-hot encoding comprises converting categorical variables into binary vectors, where each category becomes a binary column. This is useful for algorithms that cannot directly handle categorical data. Another example of categorical feature transformations is a label encoding. Label encoding comprises assigning a unique numerical label to each category in a categorical feature. This is suitable for algorithms that can work with ordinal values, but it may introduce ordinal relationships that do not exist in the data. Another example of categorical feature transformations is a frequency encoding. Frequency encoding comprises replacing each category with its frequency or count in the dataset. This can be useful when the frequency of a category is relevant information. Another example of categorical feature transformations is a target encoding (mean encoding). Target encoding comprises replacing each category with the mean of the target variable for that category. This is often used in classification problems to capture relationships between categorical features and the target.

Time-series feature transformations may include lag features. Lag features may comprise creating new features by shifting the values of a time-series variable by a specified number of time steps. This can help capture temporal dependencies. Another example of time-series feature transformation are rolling statistics. Rolling statistics comprise calculating statistical measures (e.g., mean, variance) over a rolling window of time steps. This can reveal trends and patterns in time-series data. Another example of time-series feature transformation is differencing. Differencing may comprise subtracting the previous time step's value from the current time step's value to remove trends and seasonality.

In some embodiments, the system may receive a K value for a k-fold cross-validation process to train the neural network and extract embeddings. For example, the system may prepare the first dataset and ensure that it is divided into features (input data) and the target variable (if applicable). The system may normalize or scale the data if necessary to ensure consistent feature scales. The system may determine the number of folds, k, for the cross-validation. A common choice is k=5 or k=10. The system may split the dataset into k subsets (folds), typically using stratified sampling to ensure each fold represents the overall class distribution if it is a classification problem. The system may define the neural network architecture. This could be a feedforward neural network, a convolutional neural network (CNN), a recurrent neural network (RNN), or any other suitable architecture. The system may then add a feature extraction layer to the neural network. This layer may be located before any fully connected layers and should have a lower-dimensional output that captures important information about the data. Common choices include convolutional or pooling layers in CNNs, LSTM, or GRU layers in RNNs, or any other suitable feature extraction technique. The system may then implement a training and evaluation loop within the k-fold cross-validation structure by splitting the dataset into training and validation sets for the current fold. The system may compile and train the neural network on the training data, including the feature extraction layer. After training, the system may use the validation set to evaluate model performance. The system may calculate metrics relevant to the specific problem (e.g., accuracy, F1-score, mean squared error). Optionally, the system may save the embeddings (output of the feature extraction layer) for each validation sample. The system may then, after completing all k-folds, have K sets of embeddings (one set per fold). The system may aggregate these embeddings by concatenating them or taking their mean, max, and/or other aggregation.

In some embodiments, the first model may be further based on a determined number of neurons for a penultimate layer of the neural network. For example, the system may receive a user input or determine the number automatically The penultimate layer of a neural network is the layer immediately before the output layer. In a feedforward neural network (also known as a multi-layer perceptron or MLP), the network is typically organized into three main parts: the input layer, one or more hidden layers, and the output layer. The penultimate layer is the last hidden layer before the output layer. The penultimate layer performs intermediate computations and transforms the representations learned by the previous hidden layers. The purpose of the penultimate layer is to create an abstract representation of the data that is used to make predictions. It typically has fewer neurons than the previous hidden layers, and its dimensionality is often chosen based on the complexity of the task and the desired level of abstraction in the learned features.

In deep neural networks, which have multiple hidden layers, each hidden layer learns progressively more abstract features as the system moves deeper into the network. The penultimate layer captures relatively high-level features, while the output layer translates these features into the final predictions or decisions, such as class labels in classification tasks or numerical values in regression tasks.

The penultimate layer, along with the preceding hidden layers, plays a critical role in the success of neural networks by enabling them to learn hierarchical representations of complex data, making them suitable for a wide range of machine learning tasks.

In some embodiments, the first model may be further based on a determined number of neurons for each hidden and/or output layer. For example, the model architecture may be defined by having a number of neurons in the output layer that is equal to the number of unique classes present in the dataset. The architecture is defined as having equally spaced numbers of neurons in each layer. This process divides the difference between neurons in input and penultimate/embedding layers by the number of hidden layers and determines a linear difference between the number of neurons in each layer of the network. Floor values are taken in cases of non-integer numbers of neurons in layers. Once all the numbers of neurons for each layer is identified, the layers may be built by the system with a tanh activation function between them and a softmax activation function on the output layer for classification.

At step 408, process 400 (e.g., using one or more components described above) determines a second model based on the first feature number. For example, the system may determine a second model based on the first feature number, wherein the second model comprises the neural network.

In some embodiments, the system may receive a second feature number. The system may determine a number of hidden layers for the neural network based on the second feature number. In a neural network, a hidden layer is a layer of neurons (also called units or nodes) that is positioned between the input layer and the output layer. Hidden layers are essential components of feedforward neural networks, including MLPs and deep neural networks. They are called “hidden” because they are not part of the input or output of the network; their purpose is to perform intermediate computations that help the network learn complex relationships within the data.

Each neuron in a hidden layer takes input from the neurons in the previous layer (which can be the input layer or another hidden layer) and produces an output. These outputs collectively form an intermediate representation of the input data. Hidden layers are responsible for feature extraction and transformation. They learn to capture meaningful features or patterns from the input data as it passes through the network. These features may become increasingly abstract and complex in deeper hidden layers. Typically, each neuron in a hidden layer applies a non-linear activation function to its input. This non-linearity allows neural networks to model complex, non-linear relationships in data, making them capable of solving a wide range of tasks. The number of hidden layers and the number of neurons in each hidden layer are hyperparameters that the system can adjust when designing a neural network. Deep neural networks have multiple hidden layers and are capable of learning hierarchical representations of data. The use of multiple hidden layers is a defining characteristic of deep learning. Deep neural networks have been successful in various applications, such as image recognition, NLP, and reinforcement learning, by leveraging the power of deep architectures.

During the training process, the network adjusts the weights and biases of the connections between neurons in the hidden layers to minimize the difference between its predictions and the actual target values. This optimization is typically achieved using gradient-based optimization algorithms like SGD or its variants. Common activation functions used in hidden layers include the rectified linear unit (ReLU), sigmoid, hyperbolic tangent (tanh), and variants like leaky ReLU and parametric ReLU (PReLU). These functions introduce non-linearity to the network, enabling it to approximate complex functions. The last hidden layer is followed by the output layer, which produces the final predictions or outputs of the neural network. The structure and activation function of the output layer depend on the specific task, such as regression (linear output), binary classification (sigmoid output), or multi-class classification (softmax output).

At step 410, process 400 (e.g., using one or more components described above) fits the second model on the second dataset. For example, the system may fit the second model on the second dataset using a number of neural network embedding features equal to the first feature number. For example, once the architecture of the neural network is determined, a model is fit on only the synthetic DFS feature set, with the classification as the target. This fit is performed using k-fold cross-validation, with a default K value of 10. This means than 9 sectors of the dataset will be used for training and testing embeddings will be extracted for the 10th sector, and this process will repeat 10 times. This is performed so that the neural network is only extracting embeddings for observations that have not yet been seen in its training set, but also so that embeddings can be generated across the entire feature set. The embeddings are generated by feeding in testing observations and extracting hidden values from the nodes in the penultimate layer of the neural network, resulting in a vector of values of the dimensionality specified by the user. Finally, after all embedding values are saved on this training set, the neural network is trained on the entire synthetic feature set for use in generating embeddings in production. The original DFS synthetic features are then deleted. For example, once this process is complete, the user is returned a number of neural network embedding features equal to the specified dimensionality from the user. The features also return a pipeline that performs the process on the original feature set and the trained neural network to generate embeddings from the new synthetic features and return only the embeddings back to the user.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for minimizing dimensionality of a high-dimensionality dataset during feature engineering.

2. The method of the preceding embodiment, further comprising: receiving a first dataset, wherein the first dataset comprises a first feature; processing the first dataset with a first model to generate a second dataset, wherein the second dataset comprises a second feature, wherein the second feature is a synthetic feature, and wherein the second feature is not included in the first dataset; receiving a first feature number, wherein the first feature number indicates an embedding dimension for a neural network; determining a second model based on the first feature number, wherein the second model comprises the neural network; and fitting the second model on the second dataset using a number of neural network embedding features equal to the first feature number.

3. The method of any one of the preceding embodiments, wherein processing the first dataset with the first model to generate the second dataset further comprises: retrieving the first feature from the first dataset; and performing a first function on the first feature to generate the second feature.

4. The method of claim 2, wherein processing the first dataset with the first model to generate the second dataset further comprises: recursively performing a first function on the first feature; determining a stopping condition for the first function is met; ending a recursive performance of the first function based on the stopping condition being met; and determining the second feature based on a result of the recursive performance of the first function.

5. The method of claim 2, wherein processing the first dataset with the first model to generate the second dataset further comprises: determining a first temporal pattern in the first dataset; and generating the second feature based on the first temporal pattern.

6. The method of claim 2, wherein processing the first dataset with the first model to generate the second dataset further comprises: determining a first relationship in the first dataset; and performing a first function based on the first relationship to generate the second feature.

7. The method of claim 2, wherein processing the first dataset with the first model to generate the second dataset further comprises: generating a plurality of features based the first dataset; filtering the plurality of features based on respective importance metrics; and selecting the second feature for including in the second dataset based on filtering the plurality of features based on the respective importance metrics.

8. The method of claim 2, wherein determining the second model based on the first feature number further comprises: receiving a second feature number; and determining a number of hidden layers for the neural network based on the second feature number.

9. The method of claim 2, wherein determining a second model based on the first feature number further comprises: receiving a third feature number, wherein the third feature number indicates an additional transformation to be applied to the first dataset; and generating the second dataset based on the additional transformation.

10. The method of claim 2, wherein determining the second model based on the first feature number further comprises: receiving a fourth feature number, wherein the fourth feature number indicates a K value for a k-fold cross-validation process; and training the neural network using the k-fold cross-validation process.

11. The method of claim 2, wherein determining the second model based on the first feature number further comprises: receiving a second feature number, wherein the second feature number indicates a number of neurons for a penultimate layer of the neural network; and further determining the first model based on the second feature number.

12. The method of claim 2, wherein determining the second model based on the first feature number further comprises: determining a number of unique classes present in the first dataset; and determining a number of neurons in an output layer of the neural network based on the number of unique classes.

13. The method of claim 2, wherein the second feature is based on: determining a first time period for the first dataset; determining a first statistical variation for the first dataset over the first time period; and determining the second feature based on the first statistical variation.

14. The method of claim 2, wherein the second feature is based on: comparing the first feature number to a threshold value; and determining a difference between the first feature number and the threshold value.

15. The method of claim 2, wherein the second feature is based on: generating a profile matrix for the first dataset; and determining the second feature based on the profile matrix.

16. One or more non-transitory, computer-readable mediums storing instructions that when executed by a data processing apparatus, cause the data processing apparatus to perform operations comprising those of any of embodiments 1-15.

17. A system comprising one or more processors; and memory storing instructions that, when executed by the processors, cause the processors to effectuate operations comprising those of any of embodiments 1-15.

18. A system comprising means for performing any of embodiments 1-15.

What is claimed is:

1. A system for minimizing development time in artificial intelligence models by automating hyperparameter selection based on dataset fittings of time-series data, the system comprising:
one or more processors; and
one or more non-transitory, computer-readable mediums comprising instructions that when executed by the one or more processors cause operations comprising:
receiving a first dataset, wherein the first dataset comprises a first feature;
processing the first dataset with a first model to generate a second dataset, wherein the second dataset comprises a second feature, wherein the second feature is a synthetic feature, and wherein the second feature is not included in the first dataset;
receiving a first feature number, wherein the first feature number indicates an embedding dimension for a neural network;
determining a second model based on the first feature number, wherein the second model comprises the neural network;
fitting the second model on the second dataset;
determining a number of neural network embedding features equal to the first feature number;
tuning a first untuned hyperparameter to a specific value to generate a tuned model based on the number of neural network embedding features; and
generating for display, on a user interface, a recommendation for using the tuned model for time-series forecasting.

2. A method for minimizing development time in artificial intelligence models by automating hyperparameter selection based on dataset fittings of time-series data, the method comprising:
receiving a first dataset, wherein the first dataset comprises a first feature;
processing the first dataset with a first model to generate a second dataset, wherein the second dataset comprises a second feature, wherein the second feature is a synthetic feature, and wherein the second feature is not included in the first dataset;
receiving a first feature number, wherein the first feature number indicates an embedding dimension for a neural network;
determining a second model based on the first feature number, wherein the second model comprises the neural network;
fitting the second model on the second dataset; and
determining a number of neural network embedding features equal to the first feature number.

3. The method of claim 2, wherein processing the first dataset with the first model to generate the second dataset further comprises:
retrieving the first feature from the first dataset; and
performing a first function on the first feature to generate the second feature.

4. The method of claim 2, wherein processing the first dataset with the first model to generate the second dataset further comprises:
recursively performing a first function on the first feature;
determining a stopping condition for the first function is met;
ending a recursive performance of the first function based on the stopping condition being met; and
determining the second feature based on a result of the recursive performance of the first function.

5. The method of claim 2, wherein processing the first dataset with the first model to generate the second dataset further comprises:
determining a first temporal pattern in the first dataset; and
generating the second feature based on the first temporal pattern.

6. The method of claim 2, wherein processing the first dataset with the first model to generate the second dataset further comprises:
determining a first relationship in the first dataset; and
performing a first function based on the first relationship to generate the second feature.

7. The method of claim 2, wherein processing the first dataset with the first model to generate the second dataset further comprises:
generating a plurality of features based the first dataset;
filtering the plurality of features based on respective importance metrics; and
selecting the second feature for including in the second dataset based on filtering the plurality of features based on the respective importance metrics.

8. The method of claim 2, wherein determining the second model based on the first feature number further comprises:
receiving a second feature number; and
determining a number of hidden layers for the neural network based on the second feature number.

9. The method of claim 2, wherein determining a second model based on the first feature number further comprises:
receiving a third feature number, wherein the third feature number indicates an additional transformation to be applied to the first dataset; and
generating the second dataset based on the additional transformation.

10. The method of claim 2, wherein determining the second model based on the first feature number further comprises:
receiving a fourth feature number, wherein the fourth feature number indicates a K value for a k-fold cross-validation process; and
training the neural network using the k-fold cross-validation process.

11. The method of claim 2, wherein determining the second model based on the first feature number further comprises:
receiving a second feature number, wherein the second feature number indicates a number of neurons for a penultimate layer of the neural network; and
further determining the first model based on the second feature number.

12. The method of claim 2, wherein determining the second model based on the first feature number further comprises:
determining a number of unique classes present in the first dataset; and
determining a number of neurons in an output layer of the neural network based on the number of unique classes.

13. The method of claim 2, wherein the second feature is based on:
determining a first time period for the first dataset;
determining a first statistical variation for the first dataset over the first time period; and
determining the second feature based on the first statistical variation.

14. The method of claim 2, wherein the second feature is based on:
comparing the first feature number to a threshold value; and
determining a difference between the first feature number and the threshold value.

15. The method of claim 2, wherein the second feature is based on:
generating a profile matrix for the first dataset; and
determining the second feature based on the profile matrix.

16. One or more non-transitory, computer-readable mediums comprising instructions that when executed by one or more processors cause operations comprising:
receiving a first dataset, wherein the first dataset comprises a first feature;
processing the first dataset with a first model to generate a second dataset, wherein the second dataset comprises a second feature, wherein the second feature is a synthetic feature, and wherein the second feature is not included in the first dataset;
receiving a first feature number, wherein the first feature number indicates an embedding dimension for a neural network;
determining a second model based on the first feature number, wherein the second model comprises the neural network; and
generating for display, on a user interface, a number of neural network embedding features equal to the first feature number for fitting the second model on the second dataset.

17. The one or more non-transitory, computer-readable mediums of claim 16, wherein processing the first dataset with the first model to generate the second dataset further comprises:
retrieving the first feature from the first dataset; and
performing a first function on the first feature to generate the second feature.

18. The one or more non-transitory, computer-readable mediums of claim 16, wherein processing the first dataset with the first model to generate the second dataset further comprises:
recursively performing a first function on the first feature;
determining a stopping condition for the first function is met;
ending a recursive performance of the first function based on the stopping condition being met; and
determining the second feature based on a result of the recursive performance of the first function.

19. The one or more non-transitory, computer-readable mediums of claim 16, wherein processing the first dataset with the first model to generate the second dataset further comprises:
determining a first temporal pattern in the first dataset; and
generating the second feature based on the first temporal pattern.

20. The one or more non-transitory, computer-readable mediums of claim 16, wherein the second feature is based on:
generating a profile matrix for the first dataset; and
determining the second feature based on the profile matrix.
